(19) United States
(12) Patent Application Publication
(10) Pub. No.: US 2026/0287750 A1
(43) Pub. Date: Sep. 24, 2026

(54) METHODS TO FACILITATE GLOBAL NAVIGATION SATELLITE SYSTEM (GNSS) ENHANCEMENTS FOR AN INTERNET OF THINGS (IOT) NON-TERRESTRIAL NETWORK (NTN) USER EQUIPMENT (UE)

(71) Applicant: Telefonaktiebolaget LM Ericsson (publ), Stockholm (SE)

(72) Inventors: Talha KHAN; Stefan ERIKSSON LÖWENMARK, Färentuna (SE); Johan RUNE, Lidingö (SE); Robert KARLSSON, Sundbyberg (SE); Emre YAVUZ, Stockholm (SE); Ignacio PASCUAL PELAYO, Stockholm (SE)

(21) Appl. No.: 19/472,963

(22) PCT Filed: Apr. 5, 2024
(86) PCT No.: PCT/EP2024/059330

§ 371 Date: Oct. 6, 2025

Related U.S. Application Data
(60) Provisional application No. 63/495,013, filed on Apr. 7, 2023.

(51) Int. Cl. G01S 19/20; G01S 19/25

(52) U.S. Cl. CPC G01S 19/20; G01S 19/256

(57) ABSTRACT

A method, network node and UE for supporting Global Navigation Satellite System (GNSS) positioning configurations in a wireless communication system. are disclosed. According to one aspect, a method in a user equipment (UE) includes receiving, from the network node, GNSS validity configuration information enabling the UE to conditionally transmit on an uplink channel to the network node when a GNSS validity duration has expired. The method also includes transmitting signaling on the uplink channel to the network node after the expiration of the GNSS validity duration based on the GNSS validity configuration information.

### TECHNICAL FIELD

The present disclosure relates to wireless communications, and in particular, to configurations for supporting Global Navigation Satellite System (GNSS) positioning configurations in a wireless communication system.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and user equipments (UEs), as well as communication between network nodes and between UEs. The 3GPP is also developing standards for Sixth Generation (6G) wireless communication networks.

In 3GPP, 5G system (5GS) is a new generation's radio access technology intended to serve use cases such as enhanced mobile broadband (eMBB), ultra-reliable and low latency communication (URLLC), narrow band Internet of things (NB-IoT) and machine type communication (mMTC). 5G includes the New Radio (NR) access stratum interface and the 5G Core Network (5GC). The NR physical and higher layers reuse parts of the LTE specification, and to that add needed components when motivated by new use cases. To benefit from the strong mobile ecosystem and economy of scale, the satellite network based on the terrestrial wireless access technologies including LTE and NR for satellite networks, is being specified in the 3GPP standard. A satellite network or satellite based mobile network may also be called a non-terrestrial network (NTN). Further, the mobile network with base stations may also be called a terrestrial network (TN) or non-NTN network. A satellite within an NTN may be called an NTN node, NTN satellite or a satellite.

### IoT NTN and NTN Characteristics

A satellite radio access network typically includes one or more of the following components:
A satellite that refers to a space-borne platform;
An earth-based gateway that connects the satellite to a base station or a core network, depending on the choice of architecture;
Feeder link that refers to the link between a gateway and a satellite; and/pr.
Access link, or service link, that refers to the link between a satellite and a UE.

Depending on the orbit altitude, a satellite may be categorized as low earth orbit (LEO), medium earth orbit (MEO), or geostationary earth orbit (GEO) satellite, for example:
LEO: typical heights ranging from 250-1,500 km, with orbital periods ranging from 90-120 minutes;
MEO: typical heights ranging from 5,000-25,000 km, with orbital periods ranging from 3-15 hours; and
GEO: typical height at about 35,786 km, with an orbital period of 24 hours.

A satellite which does not operate in geostationary earth orbit may also be referred to as a NGSO (Non-Geostationary Orbit) satellite. Examples of NGSO satellites are LEO and MEO satellites.

Two example architectures may be distinguished for satellite communication networks, depending on the functionality of the satellites in the system:
Transparent payload (also referred to as bent pipe architecture). The satellite forwards the received signal between the terminal and the network equipment on the ground with only amplification and a shift from uplink frequency to downlink frequency. When applied to 3GPP architectures and terminology, the transparent payload architecture may correspond to the gNB (network node) being located on the ground and the satellite forwards signals and/or data between the network node (gNB) and the UE;
Regenerative payload. The satellite may include on-board processing to demodulate and decode the received signal and regenerate the signal before sending it back to the earth. When applied to 3GPP architectures and terminology, the regenerative payload architecture may correspond to the gNB (network node) being located in the satellite.

In the work item for NR NTN in 3GPP Technical Release 17 (3GPP Rel-17), only the transparent payload architecture has been considered.

FIG. 1 is a diagram which illustrates an example architecture of a satellite network with bent pipe transponders (i.e., the transparent payload architecture). The network node (gNB) may be integrated in the gateway or connected to the gateway via a terrestrial connection (wire, optic fiber, wireless link).

A communication satellite typically generates several beams over a given area. The footprint of a beam is usually in an elliptic shape, which has traditionally been considered to be a cell, but cells consisting of the coverage footprint of multiple beams are not excluded from the scope of the 3GPP work in this area. The footprint of a beam is also often referred to as a spotbeam. The footprint of a beam may move over the earth's surface with the satellite movement, or may be earth-fixed with a beam pointing mechanism used by the satellite to compensate for the satellite's motion, for example. The size of a spotbeam may depend on the system design, which may range from tens of kilometers to a few thousands of kilometers.

In a LEO or MEO communication system, a large number of satellites deployed over a range of orbits may be required to provide continuous coverage across the full globe. Launching a mega satellite constellation may be both an expensive and time-consuming procedure. It is therefore expected that all LEO and MEO satellite constellations for some time will only provide partial earth-coverage. For some constellations dedicated to massive IoT services with relaxed latency requirements, for example, it may not even be necessary to support full earth-coverage. It may be sufficient to provide occasional or periodic coverage according to the orbital period of the constellation, for example.

A 3GPP device in RRC_IDLE or RRC_INACTIVE state may be required to perform a number of procedures including measurements for mobility purposes, paging monitoring, logging measurement results, tracking area update, and search for a new public land mobile network (PLMN) to mention a few. These procedures may consume power in devices, and a general trend in some 3GPP work has been to allow for relaxation of these procedures to prolong device battery life. This trend has been especially pronounced for IoT devices supported by reduced capability (redcap), NB IoT and LTE M, for example.

Propagation delay is an aspect of satellite communications that is different from the delay expected in a terrestrial mobile system. For a bent pipe satellite network, the round-trip delay may, depending on the orbit height, range from tens of ms in the case of LEO satellites to several hundreds of ms for GEO satellites. As a comparison, the round-trip delays in terrestrial cellular networks are typically below 1 ms.

The distance between the UE and a satellite may vary significantly, depending on the position of the satellite and thus, the elevation angle ε seen by the UE. Assuming circular orbits, the minimum distance is realized when the satellite is directly above the UE (ε=90°), and the maximum distance when the satellite is at the smallest possible elevation angle. Table 1 below shows example distances between satellite and UE for different orbital heights and elevation angles together with the one-way propagation delay and the maximum propagation delay difference (the difference from the propagation delay at ε=90°). Note that this table assumes a regenerative payload architecture. For the transparent payload case, the propagation delay between gateway and satellite may need to be considered as well, e.g., unless the base station (network node) corrects for that.

TABLE 1
Propagation delay for different orbital heights and elevation angles

| | | | Distance | | One-way | | Propagation |
|---|---|---|---|---|---|---|---|
| Orbital | | Elevation | UE <-> | | propagation | | delay |
| height | | angle | satellite | | delay | | difference |
| 600 | km | 90° | 600 | km | 2.0 | ms | — |

| | | | | | | |
|---|---|---|---|---|---|---|
| 30° | 1075 | km | 3.6 | ms | 1.6 | ms |
| 10° | 1932 | km | 6.4 | ms | 4.4 | ms |

| | | | | | | | |
|---|---|---|---|---|---|---|---|
| 1200 | km | 90° | 1200 | km | 4.0 | ms | — |

| | | | | | | |
|---|---|---|---|---|---|---|
| 30° | 1999 | km | 6.7 | ms | 2.7 | ms |
| 10° | 3131 | km | 10.4 | ms | 6.4 | ms |

| | | | | | | | |
|---|---|---|---|---|---|---|---|
| 35786 | km | 90° | 35786 | km | 119.4 | ms | — |

| | | | | | | |
|---|---|---|---|---|---|---|
| 30° | 38609 | km | 128.8 | ms | 9.4 | ms |
| 10° | 40581 | km | 135.4 | ms | 16.0 | ms |

The propagation delay may also be highly variable due to the high velocity of the LEO and MEO satellites and change in the order of 10-100 μs every second, depending on the orbit altitude and satellite velocity.

### Ephemeris Data

3GPP Technical Report (TR) 38.821, for example, discloses that ephemeris data may be provided to the UE, for example, to assist with pointing a directional antenna (or an antenna beam) towards the satellite. A UE knowing its own position, e.g., thanks to Global Navigation Satellite System (GNSS) support, may also use the ephemeris data to calculate correct timing related and/or frequency drifts, e.g., Timing Advance (TA) and Doppler shift parameters/values. The contents of the ephemeris data and the procedures on how to provide and update such data have not yet been studied.

A satellite orbit may be fully described using 6 parameters. Exactly which set of parameters is used may be decided by the user, and many different representations are possible. For example, a choice of parameters used often in astronomy is the set (a, ε, i, Ω, ω, t). Here, the semi-major axis a and the eccentricity ε describe the shape and size of the orbit ellipse, while the inclination i, the right ascension of the ascending node Ω, and the argument of periapsis @ determine its position in space, and the epoch t determines a reference time (e.g., the time when the satellites moves through periapsis). The set of these parameters is illustrated in the diagram of FIG. 2.

A two-line element set (TLE) is a data format encoding a list of orbital elements of an Earth-orbiting object for a given point in time, the epoch. As an example of a different parametrization, TLEs use mean motion n and mean anomaly M instead of a and t.

A different example set of parameters is the position and velocity vector (x, y, z, vx, vy, vz) of a satellite. These are sometimes called orbital state vectors. They may be derived from the orbital elements and vice versa since the information they contain is equivalent. All these formulations (and many others) are possible choices for the format of ephemeris data to be used in NTN.

Additionally, the ephemeris data may be accompanied with information on possible coverage area, and/or timing information, e.g., when the satellite is going to serve a certain geographical area on Earth.

### GNSS Data

To handle the timing and frequency synchronization in an NR or LTE based NTN, the device may be equipped with a Global Navigation Satellite System (GNSS) receiver. The GNSS receiver allows a device to estimate its geographical position. The UE may then determine the propagation delay, the delay variation, the Doppler shift and its variation rate based on its own and the satellite's location information.

In the 3GPP Rel-17 study item on NB-IoT and LTE-M for NTN and in the 3GPP Rel-17 and 3GPP Rel-18 work items on IoT NTN, simultaneous operation of NB-IoT/eMTC and GNSS is not assumed.

The background to this 3GPP assumption is that a cellular device may share parts of its radio frequency (RF) architecture between the cellular modem and the GNSS chip. A basic solution is to make use of the same antenna for receiving the GNSS reference signal, and for receiving and transmitting an LTE or NR signal. A switch determines if the antenna should be connected to the cellular RF frontend or the GNSS RF frontend. The switch provides the needed isolation between the cellular transmitter and the GNSS receiver, but does also prevent simultaneous GNSS and cellular operation.

### 3GPP Progress in Rel-17 IoT NTN SI

In 3GPP TR 36.763, the impact of GNSS position fix on the battery life of an IoT NTN UE has been documented. In addition, several aspects related to GNSS operation e.g., GNSS measurement gaps, were also studied and documented in TR 36.763.

### 3GPP Progress in Rel-17 IoT NTN WI

The following lists the relevant agreements on GNSS enhancements made in 3GPP RAN1 meetings during the 3GPP Rel-17 IoT NTN WI. In this WI, a GNSS validity duration parameter was introduced. Upon GNSS acquisition, a UE may autonomously determine its GNSS validity duration from the agreed set of values and report it to the network. Upon expiry of GNSS validity duration during RRC_CONNECTED state, a UE is expected to return to idle mode to refresh its GNSS position, i.e., GNSS acquisition during connected mode is not supported.

### Agreement:

For sporadic short transmission, UE in RRC_CONNECTED should go back to idle mode and re-acquire a GNSS position fix if GNSS becomes outdated.

### Agreement

The UE autonomously determines its GNSS validity duration X and reports information associated with this valid duration to the network via RRC signalling.

$$X = \{ 10 s , 20 s , 30 s , 40 s , 50 s , 60 s , 5 min , 10 min , 15 min , 20 min , 25 min , 30 min , 60 min , 90 min , 120 min , infinity \}$$

### 3GPP Progress in Rel-18 IoT NTN WI

In this WI, the focus is on long connections where the GNSS expires during the connected mode. Instead of following the default 3GPP Rel-17 procedure where a UE in RRC_CONNECTED mode returns to RRC_IDLE mode upon GNSS expiry, an enhanced UE behavior is under discussion where the UE is allowed to reacquire its GNSS position fix during the RRC_CONNECTED state. Moreover, another goal is to reduce the number of GNSS position fixes that a UE may need during RRC_CONNECTED mode in order to reduce UE power consumption.

The following lists the relevant agreements on GNSS enhancements made in 3GPP RAN1 meetings during the 3GPP Rel-18 IoT NTN WI.

### Closed Loop Time and Frequency Correction

### Agreement

Closed loop time and frequency correction, with potential enhancements, for IoT-NTN is considered to reduce the need for UE to update GNSS position fix in long connection time.

### Agreement

At least for the case when frequency error is within frequency error requirements, study the mechanisms and conditions to allow UL transmission after original GNSS validity duration expires without GNSS re-acquisition for some duration.
For future study (FFS): with legacy closed loop time correction or enhanced closed loop time correction
This mechanism is enabled/configured by eNB (network node)
FFS: whether such mechanism will be specified depends on the outcome of this study
GNSS position fix in RRC_Connected state

### Agreement

At least the following options may be considered on GNSS measurement in connected for potential enhancements for improved GNSS operations:
Option 1: UE re-acquires GNSS position fix during RLF procedure
Option 2: UE re-acquires GNSS position fix with a new gap

Note: this does not imply that a Rel-18 IoT NTN UE is mandated to support one or both of the options.

### Agreement

Further study on whether there is a need for potential enhancements on the following for long connection time
UE triggered GNSS measurement.
Network triggered GNSS measurement.

### Agreement

Support eNB (network node) to at least aperiodically trigger UE to make GNSS measurement.

### Agreement

If eNB (network node) aperiodically triggers UE to make GNSS measurement, a MAC CE is used.

### Agreement

For GNSS measurement in RRC connected, if eNB (network node) aperiodically triggers connected UE to make GNSS measurement, UE may re-acquire GNSS position fix with a gap
FFS details of gap configuration

### Agreement

The UE may re-acquire GNSS autonomously (when configured by the network) if UE does not receive eNB trigger to make GNSS measurement
FFS based on configured timing

### Agreement

On when the GNSS measurement gap starts, which is aperiodically triggered by eNB with MAC CE, RAN1 may down select one of the following alternatives:
Alt 1: the start time should be at n+X, where n is the end of MAC CE receiving subframe/slot
   FFS: details of X, e.g. predefined value or configured value
Alt 2: the start time should be based on the current GNSS validity duration with delay or without delay

### Agreement

On the length of GNSS measurement gap, which is aperiodically triggered by eNB, the gap duration should be equal to or larger than the latest UE reported GNSS position fix time duration.

FFS: whether the gap duration is configured by eNB (network node), or the gap duration is equal to the latest reported GNSS position fix time duration.

### GNSS Assistance Information

### Agreement

GNSS assistance information that UE reports to eNB (network node) at least consists of:
GNSS position fix time duration for measurement
GNSS validity duration

### Agreement

When eNB (network node) triggers UE to make GNSS measurements, UE re-acquires GNSS position fix.
FFS details of signalling
FFS how UE reports GNSS assistance information after eNB (network node) trigger and the detailed content
Note: further discuss whether a UE is expected to handle all eNB (network node) triggers

### Agreement

UE reports GNSS position fix time duration for measurement at least during the initial access stage.
which message carries this information is up to RAN2

### Agreement

In connected mode, UE may report GNSS validation duration with MAC CE.

### Agreement

UE reports only one GNSS position fix time duration for GNSS measurement at least when moving to RRC connected state.

### Agreement

The following alternatives may be considered to inform eNB (network node) the success of GNSS measurement at UE side after GNSS measurement in RRC connected.
Alt-1: The UE will report the new GNSS validity duration.
Alt-2: The reception of any UL transmission from the UE at eNB (network node) after the GNSS measurement

Thus, existing systems lack configurations for supporting GNSS uplink transmission after GNSS validity duration expiry.

### SUMMARY

Some embodiments advantageously provide methods, network nodes and user equipment (UE) for supporting GNSS positioning configurations in a wireless communication system, such as supporting GNSS uplink transmission after GNSS validity duration expiry.

A 3GPP Rel-17 IoT NTN UE (WD) typically may not be able to transmit on the uplink if its GNSS validity duration has expired. In 3GPP Rel-18 WI on IoT NTN, closed loop timing control has been considered to reduce the need of GNSS reacquisition by a UE while it is in the RRC_CONNECTED mode. Without a closed-loop timing control mechanism, a UE will need to reacquire its GNSS position whenever its GNSS validity duration expires. This is not desirable, especially for IoT devices, as GNSS reacquisition may reduce the device battery lifetime because it consumes significant power. Moreover, it is also a time-consuming operation and may last several seconds.

Some embodiments provide configurations and methods for enabling a network to allow a UE to continue transmitting on the uplink even if its GNSS validity duration has expired. Embodiments may reduce the need to send frequent TACs to the UE, which helps in reducing the signalling overhead.

Some embodiments support configurations for new timers and new UE behavior (as compared to existing systems) which enable and control a UE's transmission on the uplink after GNSS validity duration expiry, for example:
A new MAC CE for TAC in NTN which contains TA drift information; and/or
A new time alignment timer to control UE's uplink transmission despite GNSS expiry.

Some embodiments facilitate communication between eNB (network node) and UE even if the GNSS validity duration has expired, i.e., it may avoid the need to refresh GNSS measurement, which is a power-hungry operation.

Some embodiments support a new medium access control (MAC) control element (CE) for closed-loop timing advance (TA) control that reduces the need of sending TAC to the UE, since drift information is conveyed by the network node to the UE.

According to one aspect, a UE configured to communicate with a network node is provided. The UE is configured to receive, from the network node, Global Navigation Satellite System (GNSS) validity configuration information enabling the UE to conditionally transmit on an uplink channel to the network node when a GNSS validity duration has expired. The UE is also configured to transmit signaling on the uplink channel to the network node after the expiration of the GNSS validity duration based on the GNSS validity configuration information.

According to this aspect, in some embodiments, the UE is configured to start an extension timer in response to the expiration of the GNSS validity duration. In some embodiments, the UE is configured to reacquire GNSS position upon expiry of the extension timer. In some embodiments, the UE is configured to reacquire GNSS position before expiry of the extension timer in response to a trigger. In some embodiments, the UE is configured to transmit the GNSS validity duration to the network node. In some embodiments, the UE is configured to receive a gap duration for attempting to reacquire GNSS position. In some embodiments, the UE is configured to leave a connected mode upon expiry of the GNSS validity duration when no TAC is received. In some embodiments, the UE is configured to receive a GNSS position reacquisition command during a reception time interval established by a start of a reception timer. In some embodiments, the UE is configured to stop the reception timer upon reception of a GNSS measurement gap command from the network node. In some embodiments, the GNSS validity configuration information is received in a medium access control, MAC, control element, CE.

According to another aspect, a method in a user equipment, UE, configured to communicate with a network node is provided. The method includes receiving, from the network node, Global Navigation Satellite System (GNSS) validity configuration information enabling the UE to conditionally transmit on an uplink channel to the network node when a GNSS validity duration has expired. The method also includes transmitting signaling on the uplink channel to the network node after the expiration of the GNSS validity duration based on the GNSS validity configuration information.

According to this aspect, in some embodiments, the method includes starting an extension timer in response to the expiration of the GNSS validity duration. In some embodiments, the method includes reacquiring GNSS position upon expiry of the extension timer. In some embodiments, the method includes reacquiring GNSS position before expiry of the extension timer in response to a trigger. In some embodiments, the method includes transmitting the GNSS validity duration to the network node. In some embodiments, the method includes receiving a gap duration for attempting to reacquire GNSS position. In some embodiments, the method includes leaving a connected mode upon expiry of the GNSS validity duration when no TAC is received. In some embodiments, the method includes receiving a GNSS position reacquisition command during a reception time interval established by a start of a reception timer. In some embodiments, the method includes stopping the reception timer upon reception of a

GNSS measurement gap command from the network node. In some embodiments, the GNSS validity configuration information is received in a medium access control, MAC, control element, CE.

According to yet another aspect, a network node configured to communicate with a user equipment, UE, is provided. The network node is configured to determine a Global Navigation Satellite System (GNSS) validity configuration enabling the UE to conditionally transmit on an uplink channel to the network node when a GNSS validity duration has expired. The network node is configured to transmit GNSS validity configuration information to the UE.

According to this aspect, in some embodiments, the network node is configured to receive signaling on the uplink channel to the network node after the expiration of the GNSS validity duration based on the GNSS validity configuration information. In some embodiments, the GNSS validity configuration information includes a duration of an extension timer. In some embodiments, the network node is configured to transmit a timing advance command, TAC, during one of the GNSS validity duration and the duration of the extension timer. In some embodiments, the network node is configured to transmit timing advance, TA, drift information. In some embodiments, the TA drift information includes a first time derivative of a timing advance. In some embodiments, the TA drift information includes a second time derivative of the timing advance. In some embodiments, the TAC and the TA drift information is included in a medium access control, MAC, control element, CE. In some embodiments, the duration of the extension timer is based at least in part on a GNSS validity duration reported by the UE. In some embodiments, the GNSS validity configuration information includes a GNSS gap duration for attempting reacquisition of GNSS position by the UE.

According to another aspect, a method in a network node configured to communicate with a user equipment, UE, is provided. The method includes determining a Global Navigation Satellite System (GNSS) validity configuration enabling the UE to conditionally transmit on an uplink channel to the network node when a GNSS validity duration has expired. The method also includes transmitting GNSS validity configuration information to the UE.

According to this aspect, in some embodiments, the method includes receiving signaling on the uplink channel to the network node after the expiration of the GNSS validity duration based on the GNSS validity configuration information. In some embodiments, the GNSS validity configuration information includes a duration of an extension timer. In some embodiments, the method includes transmitting a timing advance command, TAC, during one of the GNSS validity duration and the duration of the extension timer. In some embodiments, the method includes transmitting timing advance, TA, drift information. In some embodiments, the TA drift information includes a first time derivative of a timing advance. In some embodiments, the TA drift information includes a second time derivative of the timing advance. In some embodiments, the TAC and the TA drift information is included in a medium access control, MAC, control element, CE. In some embodiments, the duration of the extension timer is based at least in part on a GNSS validity duration reported by the UE. In some embodiments, the GNSS validity configuration information includes a

GNSS gap duration for attempting reacquisition of GNSS position by the UE.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram which illustrates an example architecture of a satellite network;

FIG. 2 is a diagram which illustrates geometrical features of a typical satellite orbit;

FIG. 3 is a schematic diagram of an example network architecture illustrating a communication system connected via an intermediate network to a host computer according to the principles in the present disclosure;

FIG. 4 is a block diagram a network node with a wireless device over an at least partially wireless connection according to some embodiments of the present disclosure;

FIG. 5 is a flowchart of an example process in a network node for supporting Global Navigation Satellite System (GNSS) positioning configurations in a wireless communication system according to some embodiments of the present disclosure;

FIG. 6 is a flowchart of an example process in a wireless device for supporting Global Navigation Satellite System (GNSS) positioning configurations in a wireless communication system according to some embodiments of the present disclosure;

FIG. 7 is a flowchart of another example process in a network node for supporting Global Navigation Satellite System (GNSS) positioning configurations in a wireless communication system according to some embodiments of the present disclosure;

FIG. 8 is a flowchart of another example process in a wireless device for supporting Global Navigation Satellite System (GNSS) positioning configurations in a wireless communication system according to some embodiments of the present disclosure;

FIG. 9 is a signal timing diagram which illustrates an example command format according to some embodiments of the present disclosure;

FIG. 10 is a signal timing diagram which illustrates another example command format according to some embodiments of the present disclosure;

FIG. 11 is a signal timing diagram which illustrates another example command format according to some embodiments of the present disclosure;

FIG. 12 is a signal timing diagram which illustrates another example command format according to some embodiments of the present disclosure;

FIG. 13 is a signal timing diagram which illustrates another example command format according to some embodiments of the present disclosure;

FIG. 14 is a signal timing diagram which illustrates another example command format according to some embodiments of the present disclosure; and

FIG. 15 is a signal timing diagram which illustrates another example command format according to some embodiments of the present disclosure.

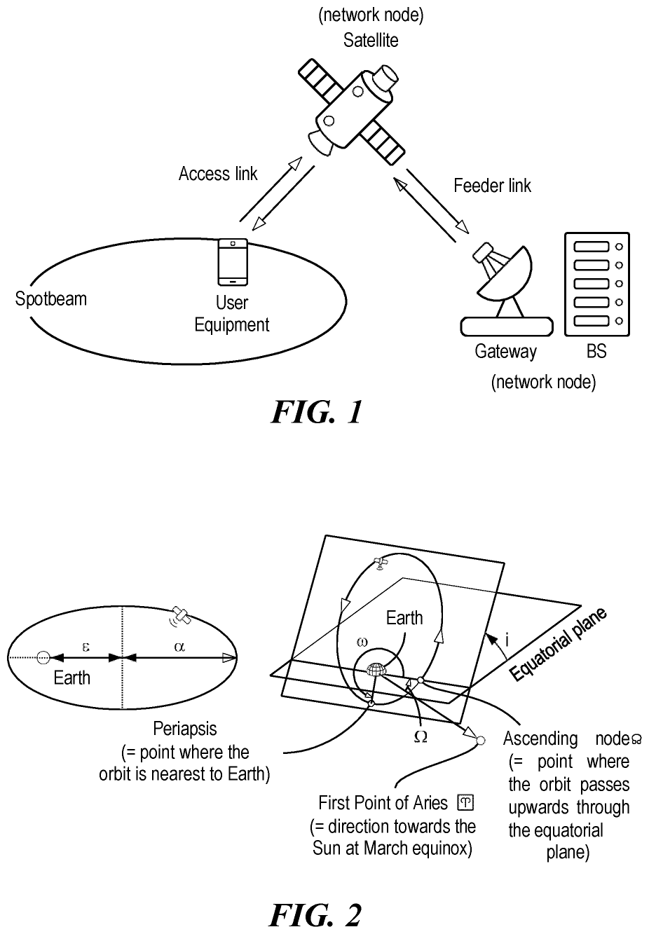

### DETAILED DESCRIPTION

Before describing in detail example embodiments, it is noted that the embodiments reside primarily in combinations of apparatus components and processing steps related to GNSS positioning configurations in a wireless communication system. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), terrestrial network node, non-terrestrial network node, location server, location management function (LMF), a satellite, etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The UE herein may be any type of wireless device capable of communicating with a network node or another UE over radio signals, such as wireless device (WD). The UE may also be a radio communication device, target device, device to device (D2D) UE, machine type UE or UE capable of machine to machine communication (M2M), low-cost and/or low-complexity UE, a sensor equipped with UE, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide configurations for supporting GNSS positioning configurations in a wireless communication system.

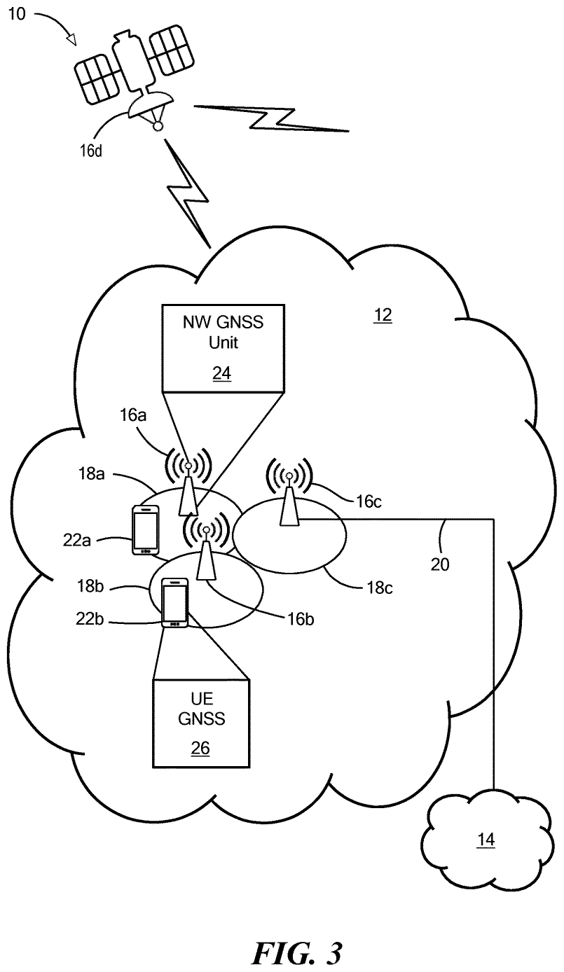

Returning now to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c, 16d (referred to collectively as network nodes 16), such as NBs, eNBs, gNBs or other types of wireless access points, each defining a corresponding coverage area 18a, 18b, 18c (referred to collectively as coverage areas 18). A coverage area 18 refers to a cell established by a network node 16. Thus, a cell forms a coverage area 18. As such, cell 18 is used interchangeably herein with coverage area 18. In a nonlimiting example, a cell 18 may comprise a satellite cell, i.e., a cell/region served directly and/or indirectly by a satellite such as network node 16d. Network nodes 16 such as network node 16d (e.g., a satellite) may communicate with any other device and/or network node 16 and/or network of system 10 and/or be configured to establish a coverage area 18. Each network node 16a, 16b, 16c, 16d is connectable to the core network 14 over a wired or wireless connection 20. A UE 22a located in coverage area 18a is configured to wirelessly connect to, or be paged by, the corresponding network node 16a. A second UE 22b in coverage area 18b is wirelessly connectable to the corresponding network node 16b. While a plurality of UEs 22a, 22b (collectively referred to as wireless devices 22) are illustrated in this example, the disclosed embodiments are equally applicable to a situation where a sole UE is in the coverage area or where a sole UE is connecting to the corresponding network node 16. Note that although only two UEs 22 and three network nodes 16 are shown for convenience, the communication system may include many more UEs 22 and network nodes 16.

Also, it is contemplated that a UE 22 may be in simultaneous communication and/or configured to separately communicate with more than one network node 16 and more than one type of network node 16. For example, a UE 22 may have dual connectivity with a network node 16 that supports LTE and the same or a different network node 16 that supports NR. As an example, UE 22 may be in communication with an eNB for LTE/E-UTRAN and a gNB for NR/NG-RAN.

A network node 16 is configured to include a NW GNSS unit 32 which is configured for supporting GNSS positioning configurations in a wireless communication system. A wireless device 22 is configured to include a UE GNSS unit 34 which is configured for supporting GNSS positioning configurations in a wireless communication system.

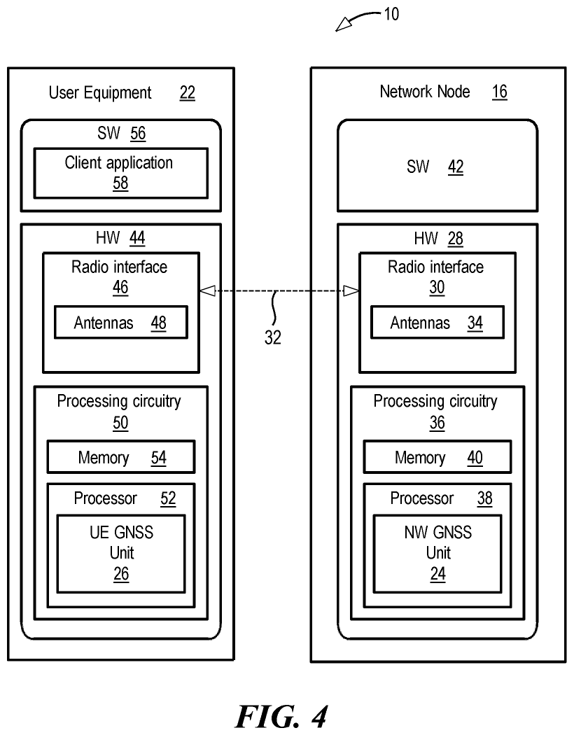

Example implementations, in accordance with an embodiment, of the UE 22, and the network node 16 discussed in the preceding paragraphs will now be described with reference to FIG. 4 The communication system 10 includes a network node 16 provided in a communication system 10 and including hardware 28 enabling it to communicate with the UE 22. The hardware 28 may include a radio interface 30 for setting up and maintaining at least a wireless connection 32 with a UE 22 located in a coverage area 18 served by the network node 16. The radio interface 30 may be formed as or may include, for example, one or more RF transmitters, one or more RF receivers, and/or one or more RF transceivers. The radio interface 30 includes an array of antennas 34 to radiate and receive signal(s) carrying electromagnetic waves.

In the embodiment shown, the hardware 28 of the network node 16 further includes processing circuitry 36. The processing circuitry 36 may include a processor 38 and a memory 40. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 42 stored internally in, for example, memory 40, or stored in external memory (e.g., database, storage array, network storage device, etc.) accessible by the network node 16 via an external connection. The software 42 may be executable by the processing circuitry 36. The processing circuitry 36 may be configured to control any of the methods and/or processes described herein and/or to cause such methods, and/or processes to be performed, e.g., by network node 16. Processor 38 corresponds to one or more processors 38 for performing network node 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to network node 16. For example, processing circuitry 36 of the network node 16 may include a NW GNSS unit 32 which is configured for supporting GNSS positioning configurations in a wireless communication system.

The communication system 10 further includes the UE 22 already referred to. The UE 22 may have hardware 44 that may include a radio interface 46 configured to set up and maintain a wireless connection 32 with a network node 16 serving a coverage area 18 in which the UE 22 is currently located. The radio interface 46 may be formed as or may include, for example, one or more RF transmitters, one or more RF receivers, and/or one or more RF transceivers. The radio interface 46 includes an array of antennas 48 to radiate and receive signal(s) carrying electromagnetic waves.

The hardware 44 of the UE 22 further includes processing circuitry 50. The processing circuitry 50 may include a processor 52 and memory 54. In particular, in addition to or instead of a processor, such as a central processing unit, and memory, the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the UE 22 may further comprise software 56, which is stored in, for example, memory 54 at the UE 22, or stored in external memory (e.g., database, storage array, network storage device, etc.) accessible by the UE 22. The software 56 may be executable by the processing circuitry 50. The software 56 may include a client application 58. The client application 58 may be operable to provide a service to a human or non-human user via the UE 22.

The processing circuitry 50 may be configured to control any of the methods and/or processes described herein and/or to cause such methods, and/or processes to be performed, e.g., by UE 22. The processor 52 corresponds to one or more processors 52 for performing UE 22 functions described herein. The UE 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to UE 22. For example, the processing circuitry 50 of the user equipment 22 may include a UE GNSS unit 34 which is configured for supporting GNSS positioning configurations in a wireless communication system.

In some embodiments, the inner workings of the network node 16 and UE 22 may be as shown in FIG. 4 and independently, the surrounding network topology may be that of FIG. 3.

The wireless connection 32 between the UE 22 and the network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

Although FIGS. 3 and 4 show various “units” such as NW GNSS unit 24 and UE GNSS unit 26 as being within a respective processor, it is contemplated that these units may be implemented such that a portion of the unit is stored in a corresponding memory within the processing circuitry. In other words, the units may be implemented in hardware or in a combination of hardware and software within the processing circuitry.

In some embodiments, the network node 16 may correspond to one or more of a satellite, a base station, a location server, and a location management function.

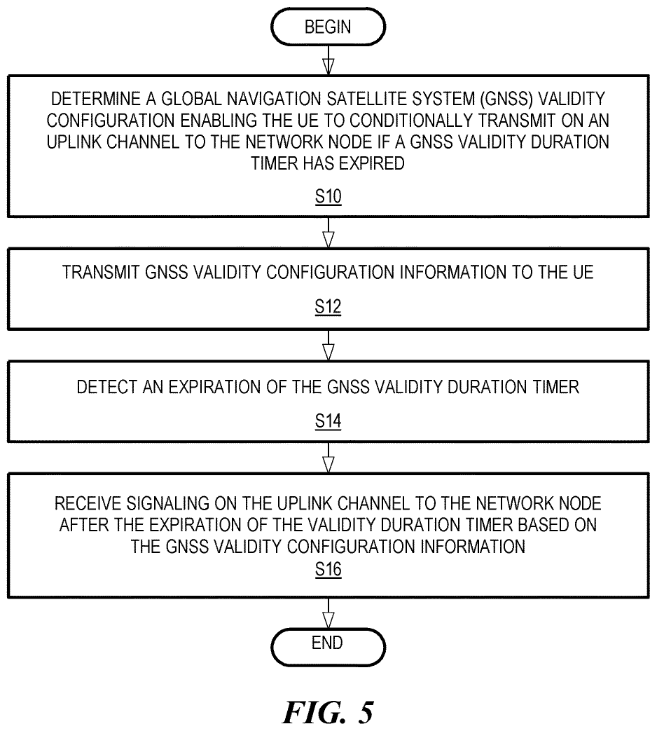

FIG. 5 is a flowchart of an example process in a network node 16 (e.g., a land-based network node and/or a satellite-based network node) for supporting GNSS positioning configurations in a wireless communication system. One or more blocks described herein may be performed by one or more elements of network node 16 such as by one or more of processing circuitry 68 (including the NW GNSS unit 24), processor 70, radio interface 62 and/or communication interface 60. Network node 16 is typically configured to determine (Block S10) a Global Navigation Satellite System (GNSS) validity configuration enabling the UE 22 to conditionally transmit on an uplink channel to the network node if a GNSS validity duration timer has expired. Network node 16 is configured to transmit (Block S12) GNSS validity configuration information to the UE. In some examples, the Network node 16 is further configured to detect (Block S114) an expiration of the GNSS validity duration timer. In some examples the Network node 16 is further configured to receive (Block S16) signaling on the uplink channel to the network node after the expiration of the validity duration timer based on the GNSS validity configuration information. In some embodiments, the network node 16 which transmit the configuration information may be the same or different than the network node 16 which receives the signaling on the uplink channel.

In some embodiments, network node 16 is further configured to start an extension timer in response to the expiration of the validity duration timer, and transmit, to the UE 22, an indication configured to cause the UE 22 to stop reacquiring a GNSS position and/or stop the extension timer based on the UE 22 having no additional pending uplink data to send to the network node 16. In some embodiments, the network node 16 is further configured to the network node is further configured to determine a transmission timing error of the UE 22, determine a drift parameter for the UE 22, and to transmit a timing advance command to the UE 22 based on the transmission timing error being below a threshold error level, where the receiving of the signaling on the uplink channel from the UE 22 after the expiration uses a GNSS measurement performed prior to the expiration of the validity duration timer and is based on the drift parameter.

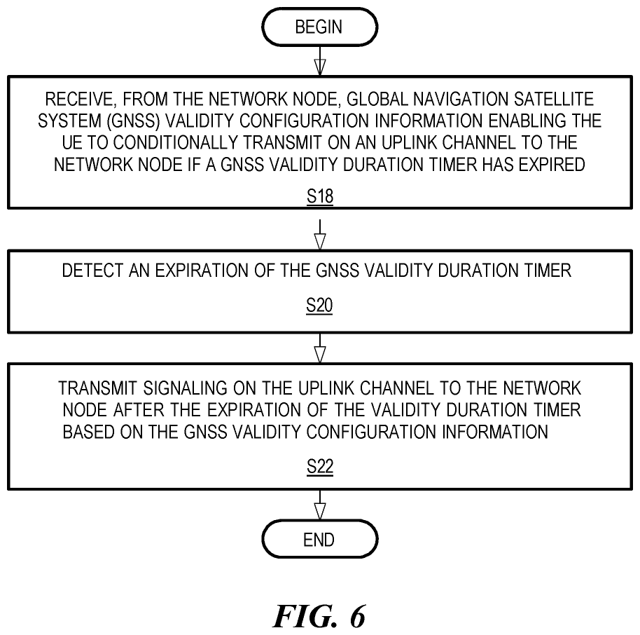

FIG. 6 is a flowchart of an example process in a wireless device 22 according to some embodiments of the present disclosure for supporting GNSS positioning configurations in a wireless communication system. One or more blocks described herein may be performed by one or more elements of wireless device 22 such as by one or more of processing circuitry 84 (including the UE GNSS unit 26), processor 86, radio interface 82 and/or communication interface 60. Wireless device 22 is configured to receive (Block S18), from the network node 16 (e.g., a land-based network node and/or a satellite-based network node 16), Global Navigation Satellite System (GNSS) validity configuration information enabling the UE 22 to conditionally transmit on an uplink channel to the network node 16 (or another network node 16, as indicated/configured) if a GNSS validity duration timer has expired. The UE 22 is further configured to detect (Block S20) an expiration of the GNSS validity duration timer. The UE 22 is further configured to transmit (Block S22) signaling on the uplink channel to the network node 16 (and/or another network node 16) after the expiration of the validity duration timer based on the GNSS validity configuration information.

In some embodiments, the UE 22 is further configured to start an extension timer in response to the expiration of the validity duration timer, and receive, from the network node 16, an indication configured to cause the UE 22 to stop reacquiring a GNSS position and/or stop the extension timer based on the UE 22 having no additional pending uplink data to send to the network node 16. In some embodiments, the UE 22 is further configured to receive a timing advance command from the network node based on a transmission timing error of the UE 22 being below a threshold error level, and to perform a GNSS measurement prior to the expiration of the validity duration timer, where the transmitting of the signaling on the uplink channel to the network node after the expiration uses the GNSS measurement and is further based on a drift parameter indicated in the timing advance command.

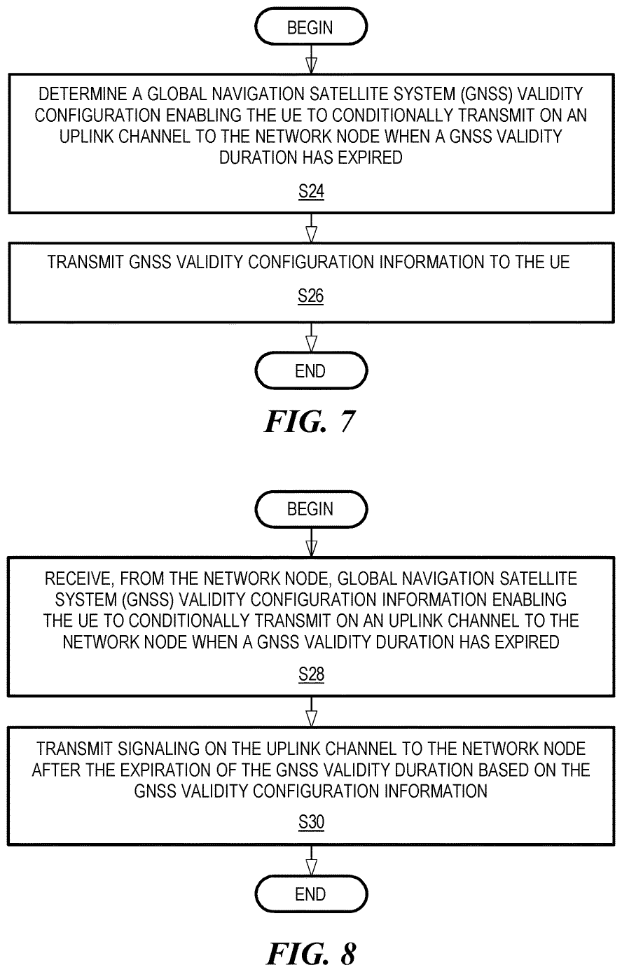

FIG. 7 is a flowchart of an example process in a network node 16 (e.g., a land-based network node and/or a satellite-based network node) for supporting GNSS positioning configurations in a wireless communication system. One or more blocks described herein may be performed by one or more elements of network node 16 such as by one or more of processing circuitry 68 (including the NW GNSS unit 24), processor 70, radio interface 62 and/or communication interface 60. Network node 16 is configured to determine (Block S24) a Global Navigation Satellite System (GNSS) validity configuration enabling the UE 22 to conditionally transmit on an uplink channel to the network node 16 when a GNSS validity duration has expired. The method also includes transmitting (Block S26) GNSS validity configuration information to the UE 22.

In some embodiments, the method includes receiving signaling on the uplink channel to the network node 16 after the expiration of the GNSS validity duration based on the GNSS validity configuration information. In some embodiments, the GNSS validity configuration information includes a duration of an extension timer. In some embodiments, the method includes transmitting a timing advance command, TAC, during one of the GNSS validity duration and the duration of the extension timer. In some embodiments, the method includes transmitting timing advance, TA, drift information. In some embodiments, the TA drift information includes a first time derivative of a timing advance. In some embodiments, the TA drift information includes a second time derivative of the timing advance. In some embodiments, the TAC and the TA drift information is included in a medium access control, MAC, control element, CE. In some embodiments, the duration of the extension timer is based at least in part on a GNSS validity duration reported by the UE 22. In some embodiments, the GNSS validity configuration information includes a GNSS gap duration for attempting reacquisition of GNSS position by the UE 22.

FIG. 8 is a flowchart of an example process in a wireless device 22 according to some embodiments of the present disclosure for supporting GNSS positioning configurations in a wireless communication system. One or more blocks described herein may be performed by one or more elements of wireless device 22 such as by one or more of processing circuitry 84 (including the UE GNSS unit 34), processor 86, radio interface 82 and/or communication interface 60. Wireless device 22 is configured to receive (Block S28), from the network node 16, Global Navigation Satellite System (GNSS) validity configuration information enabling the UE 22 to conditionally transmit on an uplink channel to the network node 16 when a GNSS validity duration has expired. The method also includes transmitting (Block S30) signaling on the uplink channel to the network node 16 after the expiration of the GNSS validity duration based on the GNSS validity configuration information.

In some embodiments, the method includes starting an extension timer in response to the expiration of the GNSS validity duration. In some embodiments, the method includes reacquiring GNSS position upon expiry of the extension timer. In some embodiments, the method includes reacquiring GNSS position before expiry of the extension timer in response to a trigger. In some embodiments, the method includes transmitting the GNSS validity duration to the network node 16. In some embodiments, the method includes receiving a gap duration for attempting to reacquire GNSS position. In some embodiments, the method includes leaving a connected mode upon expiry of the GNSS validity duration when no TAC is received. In some embodiments, the method includes receiving a GNSS position reacquisition command during a reception time interval established by a start of a reception timer. In some embodiments, the method includes stopping the reception timer upon reception of a GNSS measurement gap command from the network node 16. In some embodiments, the GNSS validity configuration information is received in a medium access control, MAC, control element, CE.

Having described the general process flow of arrangements of the disclosure and having provided examples of hardware and software arrangements for implementing the processes and functions of the disclosure, the sections below provide details and examples of arrangements for supporting GNSS positioning configurations in a wireless communication system.

### Generalization and Terminology Simplifications

Some embodiments described herein may be described mainly in terms of LTE based (including IoT) NTNs, but it is to be understood that such embodiments may be equally applicable in an NTN based on NR (including, e.g., IoT) technology.

The term “network” may be used herein to refer to a network node 16, which typically may be an eNB (e.g., in an LTE based NTN such as IoT NTN), and which may also be a gNB (e.g., in a NR based NTN), and/or may correspond to a base station or an access point in another type of network, or any other network node 16 with the ability to directly or indirectly communicate with a UE 22.

The most well-known GNSS is the American Global Positioning System (GPS), but there are also other similar systems which may be capable of providing the functionality utilized in the proposed solution, e.g., the Russian Global Navigation Satellite System (GLONASS), the Chinese BeiDou Navigation Satellite System, the European Galileo, etc.

The terms “connected mode”, “RRC_CONNECTED state” or “RRC_CONNECTED mode” may be used interchangeably in this document.

In the following embodiments, the terms aperiodic, event-based and periodic GNSS measurement events may be used. Periodic GNSS measurement event may correspond to the UE 22 performing GNSS measurements in a time-periodic manner according to a GNSS measurement command and the configuration sent in that command. Event-based GNSS measurement may correspond to the UE 22 performing one or more measurements according to a GNSS measurement command and the configuration sent in that command such that the occurrence of those measurements is tied to an event (e.g., the expiry of GNSS validity duration with or without a certain time offset).

Unless otherwise stated, the term periodic may be used herein to refer to the time-periodic GNSS measurements, as well as the event-based GNSS measurements. If further distinction between the two types is intended, the terms “time-periodic” measurement and “event-based” GNSS measurement may be used, for example.

The symbols M₁, M₂, M₃, . . . , Mₙ, . . . may be used herein to refer to the first, second, third, and n^{th} GNSS measurement that a UE 22 performs in RRC_CONNECTED state, for example.

When a signaling message or parameter, or a UE 22 behavior, is specified in a standard, in this disclosure, such behavior may be referred to as “standardized”, “specified” or “specified in a standard”. That is, these expressions/terms may be considered to be equivalent.

The term/expression “GNSS position fix time duration” may refer to the time the UE 22 needs to perform a GNSS position fix (i.e., a successful GNSS position measurement), which may vary, e.g., depending on the UE's 22 GNSS state (often referred to as “hot”, “warm” and “cold” state, or “hot start”, “warm start” and “cold start”).

Embodiments herein may utilize a variety of specific values for the timers. For example, it may be assumed in some embodiments that a default value of 0 for the described timers (if not configured by the network) may be used, unless stated otherwise herein.

### Timers and UE 22 Behavior for GNSS Validity Expiry and Extension and GNSS Reacquisition

A UE 22 may, in some cases, be restricted from transmitting on the uplink if its GNSS position is invalid. However, with a closed-loop timing control mechanism, the network node 16 may enable a UE 22 to transmit on the uplink under certain conditions. Embodiments herein may support timers and may provide configurations for UE 22 behaviour upon GNSS acquisition, expiry and/or extension.

One or more of the described timers may be specified, for example, in a 3GPP specification or other standard document, according to the following examples.

### GNSS Position Validity and Timer T3xx

In some embodiments, a new timer, e.g., denoted by T3xx herein, is introduced, which may be started (e.g., by UE 22 and/or network node 22) when the UE 22 acquires a GNSS position fix and runs for a duration given by the GNSS validity duration (determined, e.g., by the UE 22). Alternatively, it is started when the UE 22 acquires a GNSS position fix and runs for a duration of time given by the remaining GNSS validity duration (e.g., with reference to the instant the timer is started), e.g., determined by the UE 22.

In some embodiments, a necessary condition to consider the UE's 22 GNSS position valid is that T3xx must be running, i.e., that it has not expired. If GNSS position is invalid, the UE 22 may be restricted from (e.g., not allowed to, according to a configuration) transmitting on the uplink.

In some embodiments, the network node 16 (eNB) may be configured to indicate to the UE 22 (for example using signalling in RRC, MAC or DCI) that the UE 22 may not reacquire the GNSS position when T3xx expires, for example, if the UE 22 has no more data to send and the network node 16 (eNB) does not have more data to send to the UE 22.

### GNSS Validity Extension and Timer T3xx_Ext

Another possibility currently under discussion in the 3GPP RAN1 WG is that the network indicates to the UE 22 whether it may transmit on the uplink if its GNSS validity duration has expired. There are various ways to indicate this, e.g., using a 1-bit flag or by explicitly extending the GNSS validity duration, but the details have not been discussed yet.

In this regard, embodiments of the present disclosure may support one or more of the following configurations and methods (i.e., one or more of the following options may be specified):
The network node 16 may introduce a 1-bit flag (e.g., “xxxGNSS-extension”) in the GNSS reacquisition command sent to the UE 22.
The network node 16 sends xxxxGNSS-extension in a separate message using DCI, MAC or RRC signalling.
The network node 16 indicates this flag as part of SI.
Any combination of the above options.

In some embodiments, the xxxGNSS-extension flag may be associated with a new validity duration called GNSS validity extension duration, which may be fixed in the standard specification and/or configured by the network node 16, for example. In some embodiments, the GNSS validity extension duration may be indicated by the network node 16 along with the xxxGNSS-extension flag.

In another alternative, instead of an absolute value, the value of GNSS validity extension may be a fixed proportion (%) or a combination of other UE 22-specific GNSS related time parameters such as the GNSS validity duration or the GNSS position time fix duration for measurement. This relative quantity may be UE 22-specific and may be fixed in the standard and/or configurable by the network node 16, by the methods described herein, for example.

Alternatively, in some embodiments, the quantity or duration may be indicated separately by the network node 16. For example, this duration may be indicated as part of initial RRC configuration during connection setup whereas the xxxGNSS-extension flag may be indicated using one or more of the methods described herein, for example.

In some embodiments, a new UE 22 timer, e.g., denoted by T3xx_ext, may be provided, which runs for a duration given by the GNSS validity extension duration provided by the network node 16, e.g., via broadcast or dedicated signalling. A necessary condition for this timer to run may be, for example, that the xxxGNSS-extension flag (with a value that indicates GNSS extension by the network) be received by the UE 22.
In some embodiments, T3xx_ext (or another similar or equivalent timer) may be initiated upon the expiry of GNSS validity duration and/or T3xx.
In some embodiments, the timer may be initiated upon reception of xxxGNSS-extension flag (with a value that indicates GNSS extension by the network) and the GNSS validity extension duration (whichever is received later) if indicated by the network in a UE 22-specific message. For example, even if the GNSS validity duration has not expired (T3xx is still running), if the UE 22 receives command(s) for GNSS extension, it stops T3xx and starts T3xx_ext.
In some embodiments, the timer may be initiated using one or more of the above methods, e.g., after inserting a fixed delay, e.g., after adding a fixed delay upon the expiry of T3xx.

In some embodiments, the network node 16 (eNB) may be configured to indicate to the UE 22 (for example, using signalling in RRC, MAC or DCI) that it may stop reacquiring the GNSS position and stop the T3xx_ext timer, for example, if the UE 22 has no more data to send and the network node 16 (eNB) does not have more data to send to the UE 22 and the network node 16 (eNB) may need to stop sending TAC MAC Ces, e.g., to keep the UE 22 in synch outside of the GNSS validity duration.

In some embodiments, a timer, e.g., T3xx, starts upon acquiring a valid GNSS position and when it expires UE 22 is configured to leave the connected mode unless the network node 16 (eNB) sends a Timing Advance Command MAC CE (or Timing Advance Commands by another means) to make adjustments so that the UE 22 may continue to remain in sync. When this Timing Advance Command MAC CE (or any other equivalent signal) is received, UE 22 may be configured to start another timer, e.g., denoted by T3zz in this text, or T3xx_ext, as described above. The value of this timer may be a fixed, semi-static or dynamic value, for example, which may be provided via broadcast or dedicated signaling, e.g., by network node 16. The network node 16 (eNB) may provide a measurement gap for enabling/configuring the UE 22 to acquire the GNSS position in the meantime, i.e., before T3zz or T3xxx_ext, expires, or another Timing Advance Command MAC CE to restart T3zz or T3xxx_ext. If T3zz or T3xx_ext expires with no new Timing Advance Command, the UE 22 may be configured to consider itself not in sync in the UL, and leaves the connected mode accordingly.

### GNSS Fallback Mechanism for Autonomous GNSS Reacquisition and Timers T3yy_A and T3yy

In some embodiments, a new UE 22 timer denoted by T3yy_A may be defined, which runs (e.g., on UE 22) for a duration which is either fixed in the specification and/or indicated by the network node 16, for example, using MAC or RRC signalling. A UE 22 may be configured to wait to receive a GNSS reacquisition command(s) from the network node 16 while T3yy_A is running. In some embodiments, T3yy_A may be stopped (e.g., by UE 22) upon successful reception of a GNSS measurement gap command from the network node 16 (eNB). In another embodiment, T3yy_A may be stopped (e.g., by UE 22) upon successful reception of a GNSS measurement gap command from the network node 16 (eNB) after a lapse of a fixed (as per the specification) or network-configured time delay, for example.

In some embodiments, a new UE 22 timer denoted by T3yy may be defined which runs for a duration which is either fixed in the specification or indicated by the network node 16, for example, using MAC or RRC signalling. A UE 22 may be configured to attempt to autonomously acquire a GNSS position fix while T3yy is running, for example. Alternatively, if the value of T3yy is not configured by the network node 16, the UE 22 may be configured to autonomously decide to assign a value, e.g., equal or slightly larger than its reported GNSS position fix time duration for measurement.

In one embodiment, T3yy may be initiated according to:
Upon T3xx expiry if xxxxGNSS_extension is not configured and T3yy_A is not configured;
Upon T3xx_ext expiry if xxxxGNSS_extension is configured and T3yy_A is not configured; and/or
Upon T3yy_A expiry if the UE 22 did not receive any command for GNSS reacquisition (using a network-configured GNSS measurement gap) from the network node 16, e.g., while T3xx or T3xx_ext or T3yy_A was still running.

In another embodiment, T3yy may be initiated according to:
Upon T3xx expiry if xxxxGNSS_extension is not configured and if the UE 22 did not receive any command for GNSS reacquisition (using a network configured GNSS measurement gap) from the network node 16 while T3xx was still running; and/or
Upon T3xx_ext expiry if xxxxGNSS_extension is configured if the UE 22 did not receive any command for GNSS reacquisition (using a network configured GNSS measurement gap) from the network node 16 while T3xx or T3xx_ext were still running.

In one embodiment, T3yy may be stopped upon successful reacquisition of GNSS position fix by the UE 22. In another embodiment, T3yy may be stopped after a duration, which may be specified in the specification or configured by the network node 16, for example.

In some embodiments, the UE 22 may be configured to restart or extend the T3yy timer, e.g., if configured by the network node 16. For example, this extension may be in increments of a non-negative integer N times a parameter X, or a scalar S (where 0≤S≤1) times the parameter X, or a real number P times a parameter X, where X may be the same value as the timer T3yy that just expired or it may be set to the position fix timer duration value reported by the UE 22 to the network node 16 (eNB), e.g., as part of GNSS assistance information. For example, if GNSS position fix is not successful, the UE 22 may be configured to extend the T3yy timer by up to N times the position fix time duration reported to the network node 16, where the number N may be either fixed in the specification or configured by the network node 16, for instance. For instance, if N=2, UE 22 may be configured to extend the T3yy once by an amount given by position fix time duration. If UE 22 still cannot acquire GNSS position fix, it may be configured to extend it by another position fix time duration. If still unsuccessful, it may be configured to initiate the procedure to switch to idle mode.

In some embodiments, the UE 22 is configured to indicate to the network node 16 in GNSS assistance information whether or not it will extend the timer T3yy and the amount by which it will extend. For example, it may include the value N in GNSS assistance information. If N=0 or Nis not included, then UE 22 may be configured to not extend T3yy. Otherwise, the network node 16 will know that the UE 22 may extend it by a maximum of N times the parameter position fix time duration. In a sub-embodiment, the network node 16 may be configured to indicate to the UE 22 whether it allows it to extend its timer T3yy by an amount N indicated by the UE 22. Alternatively, the network node 16 may indicate a different value (e.g., 0 or N−1) by which the UE 22 may extend its timer T3yy either in response to the UE's 22 indicated extension parameter as per GNSS assistance information or irrespective of the GNSS assistance information messages.

Note: the embodiments for T3yy extension may also be applied to extension of other timers described in this embodiment, such as timer T3yy_A or T3xx_ext.

In some embodiments, the network node 16 (eNB) may be configured to indicate to the UE 22 (for example using signalling in RRC, MAC or DCI) that it may stop reacquiring the GNSS position and stop the T3yy_A and the T3yy timer, for example if the UE 22 has no more data to send and the network node 16 (eNB) does not have more data to send to the UE 22, and the network node 16 (eNB) needs to stop sending TAC MAC Ces, e.g., to keep the UE 22 in synch outside of the GNSS validity duration.

UE 22 actions upon GNSS reacquisition in RRC_CONNECTED mode Upon acquiring a successful GNSS position fix, the UE 22 may be configured to (one or more of):
stop timer T3xx_ext, if running.
stop timer T3yy_A, if running.
stop timer T3yy, if running.
stop timer Tzz, if running.
start or restart timer T3xx with the timer value set to the remaining time of the GNSS validity duration or using one of the methods described herein.

### Example Scenario

GNSS validity duration expires, GNSS extension is configured, GNSS reacquisition trigger command not received from network node 16 (eNB)

Embodiments of the present disclosure may be configured to account for both the potential GNSS extension and the potential timer-based autonomous reacquisition of GNSS, e.g., if the UE 22 does not receive a command from the network to reacquire GNSS position despite waiting for a fixed/specified or network-configured time duration after GNSS validity duration expiry (e.g., this may occur because the network did not configure a GNSS measurement gap for the UE 22 and/or because the network node 16 command to trigger GNSS measurement gap and/or GNSS gap configuration details was not received or correctly decoded at the UE 22), for example, when:
UE 22 did not receive a network command (e.g., MAC and/or RRC trigger) for GNSS reacquisition while T3xx was running;
UE 22 received a command to allow GNSS extension (i.e., xxxGNSS-extension was configured) while T3xx was running;
UE 22 need not reacquire GNSS until T3xx_ext is running, i.e., it may continue to transmit on the UL unless it receives a network command to reacquire GNSS while T3xx_ext is running;
If T3yy_A is configured, UE 22 may be configured to wait to receive a MAC/RRC trigger for GNSS reacquisition while T3yy_A is running. Otherwise (if T3yy_A is not configured or if network command to reacquire GNSS position fix is not received until T3yy_A expiry), UE 22 may be configured to start T3yy timer and will initiate the procedure to acquire GNSS position fix autonomously while T3yy is running;
If UE 22 received a MAC/RRC trigger for GNSS reacquisition, it may be configured to do so using the configured GNSS gap and the usual procedure (i.e., after which a GNSS position fix may follow).
Using network-controlled TA adjustments to extend the UE's 22 usage of its latest GNSS measurement.

As the UE's 22 GNSS validity duration, as reported to the network node 16 (e.g. eNB), approaches its expiration time, the network node 16 may determine that the UE's 22 transmission timing error (as detected by the network node 16 when receiving the UE's 22 transmission) is small enough to allow the UE 22 to continue using its latest GNSS measurement for further UE 22 autonomous TA calculations beyond the time when the UE's 22 GNSS validity duration expires, and to further support such extended usage of the GNSS validity duration, the network node 16 may optionally use Timing Advance Command MAC Ces to keep the UE's 22 transmission timing within the cyclic prefix (CP).

To this end, when the GNSS validity timer is about to expire, the network node 16 (eNB) may be configured to analyze the received UL synchronization of the UE 22 and determine if the UE 22 should be allowed to continue to transmit in the UL, supported by Timing Advance Command MAC Ces from the network node 16 (eNB).

In some embodiments, a new MAC CE for TA adjustment may be defined, which may contain a Timing Advance Command+optional Timing Advance drift information, where the TA drift information may include the drift (i.e., the time derivative) and optionally the drift variation (i.e., the second time derivative). As used herein, this TA drift information may be referred to as TA drift and TA drift variation, wherein these may refer to either of:
Option 1: The complete TA, i.e., covering the path between the UE 22 and the UL/DL alignment/time synchronization reference point (which typically is in the network node 16 (gNB or the eNB, for instance), but may also be in the satellite or, theoretically, anywhere on the feeder link path between the network node 16/gNB and the satellite). That is, with this option the TA drift and TA drift variation may refer to the first and second time derivatives of the complete TA.
Option 2: The service link part of the TA, i.e., the service link RTT. That is, with this option the TA drift and TA drift variation refers to the first and second time derivatives of the service link part of the TA (i.e. the service link RTT).
Option 3: The amount of TA adjustment to apply referring to the TA that UE 22 used when it received the MAC CE with the TA adjustment together with drift and/or drift variation. That is, with this option, the TA drift and TA drift variation refers to the first and second time derivatives of the TA adjustment to be applied (e.g., to the same reference base TA which is the TA the UE 22 was using when it received the MAC CE).

The following is an example of how the TA drift information may be used to calculate (e.g., by UE 22, network node 16, etc.) a TA at time t (i.e., TA(t)), based on the TA drift information and the TA that was valid after the UE 22 had applied the adjustment received in the MAC CE at time to (i.e. TA(t0)). The example may assume that option 1 above is used.

$$TA ( t ) = TA ( t 0 ) + {TA}_{drift} \times ( t - t 0 ) + {TA}_{drift \_ variation} \times {( t - t 0 )}^{2}$$

Or equivalently expressed:

$$TA ( t ) = TA ( t 0 ) + \frac{dTA}{dt} \times ( t - t 0 ) + \frac{{d}^{2} TA}{{dt}^{2}} \times {( t - t 0 )}^{2}$$

In the above two example equations, TA_{drift} is the TA drift, TA_{drift_variation} is the TA drift variation, t0 is the time when the UE received the MAC CE with the TA adjustment and TA drift information, and t−t0 is the time that has elapsed since the UE received the MAC CE.

In some embodiments, other definitions of t0 than the time the UE 22 receives the MAC CE may be used. It may for instance be specified to be the frame border that precedes the UE's 22 MAC CE reception, the frame border following the UE's 22 MAC CE reception or the frame border that is the closest to the (start) of the UE's 22 MAC CE reception. Other possibilities include that the network node 16 explicitly indicates t0 in the MAC CE, e.g., as a SFN or a SFN combined with a slot or as a UTC timestamp. Some embodiments may support specifying an option to explicitly indicate t0 in the MAC CE, and a default to (e.g., one of the options mentioned above) the UE 22 may be configured to apply in absence of the explicit indication.

The new MAC CE for TA adjustment may further be associated with a new Time Alignment Timer (that is configured with a finite value and which may be called e.g. TimeAlignmentTimer2) where to is aligned with the t0 indicated in MAC CE as described above or an explicit reference point, and the reception of the new MAC CE may indicate to the UE 22 that it is allowed to transmit after the GNSS validity duration has expired, as long as the new Time Alignment Timer is running. Optionally, the value of the new Time Alignment Timer may be explicitly indicated in the new MAC CE, or the indication to the UE 22 whether it is allowed to transmit after the GNSS validity duration has expired may be explicitly indicated with a bit in the new MAC CE.

The new MAC CE, e.g., called Extended Timing Advance Command MAC CE (abbreviated ETAC or ETAC MAC CE) may, e.g., have one of the following formats.

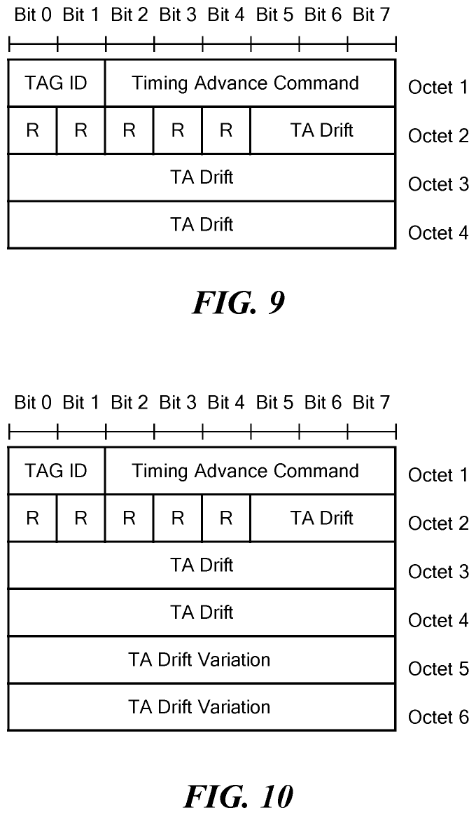

FIG. 9 is a timing diagram which illustrates an Extended Absolute Timing Advance Command MAC CE format example with TA drift, according to one or more embodiments of the present disclosure. The bits indicated by “R” are reserved, e.g., should be set to 0 by the sender (e.g., UE 22 and/or network node 16) and should be ignored by the receiver (e.g., UE 22 and/or network node 16). Thus, in some embodiments, the format as illustrated in the timing diagram of FIG. 9 may be used. For example, the new MAC CE may include a TA drift parameter, in addition to the regular content of a Timing Advance Command MAC CE.

FIG. 10 illustrates another timing diagram with an Extended Absolute Timing Advance Command MAC CE format example with TA drift and TA drift variation, according to some embodiments of the present disclosure. The bits indicated by “R” are reserved, should be set to 0 by the sender (e.g., UE 22 and/or network node 16) and should be ignored by the receiver (e.g., UE 22 and/or network node 16). With this format, the new MAC CE may include a TA drift parameter and a TA drift variation parameter, in addition to the regular content of a Timing Advance Command MAC CE.

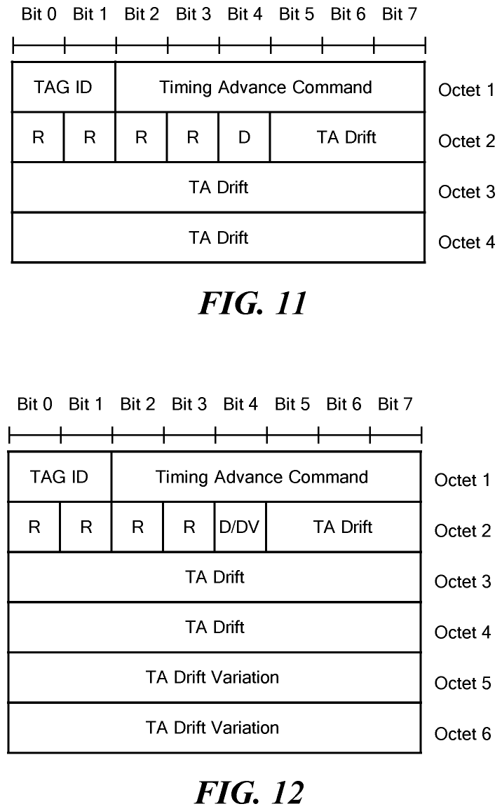

FIG. 11 illustrates another timing diagram with Extended Absolute Timing Advance Command MAC CE format example with optional TA drift, whose presence is controlled by a flag (i.e., single bit indicator), according to some embodiments of the present disclosure. The “D” bit indicates the presence or absence of the TA Drift parameter. Set to 1 indicates presence, set to 0 indicates absence. The bits indicated by “R” are reserved, should be set to 0 by the sender (e.g., UE 22 and/or network node 16) and should be ignored by the receiver (e.g., UE 22 and/or network node 16). With this format, the new MAC CE may include an optional TA drift parameter, whose presence is controlled by a single-bit flag, in addition to the regular content of a Timing Advance Command MAC CE.

In some embodiments, an alternative to using an optionally included TA drift parameter is to use two MAC CE formats, one including a TA drift parameter and one which does not include a TA drift parameter, and then the network node 16 may be configured to choose which one to provide, e.g., on a case-by-case basis, on a group-wise basis, for a time period, etc. In some embodiments, which of the two MAC CE formats to use may be configurable, e.g., as indicated in and/or based on system information.

FIG. 12 illustrates another timing diagram with an Extended Absolute Timing Advance Command MAC CE format example with optional TA drift and TA drift variation, whose common presence is controlled by a flag (i.e., a single bit indicator), according to some embodiments of the present disclosure. The “D/DV” bit may indicate the presence or absence of the TA Drift and TA Drift Variation parameters. Set to 1 indicates presence, set to 0 indicates absence. The bits indicated by “R” are reserved, should be set to 0 by the sender (e.g., UE 22 and/or network node 16) and should be ignored by the receiver (e.g., UE 22 and/or network node 16). With this format, the new MAC CE may include optional TA drift and TA drift variation parameters, whose combined presence may be controlled by a single-bit flag, in addition to the regular content of a Timing Advance Command MAC CE.

In some embodiments, an alternative to using optionally included TA drift and TA drift variation parameters is to use two MAC CE formats, e.g., one including a TA drift and TA drift parameters and one which does not include TA drift and TA drift variation parameters, and then the network node 16 may be configured to choose which one to provide, even on a case-by-case basis, group-wise basis, for a time period, etc. In some embodiments, which of the two MAC CE formats to use may be configurable, e.g., as indicated by and/or based on the system information.

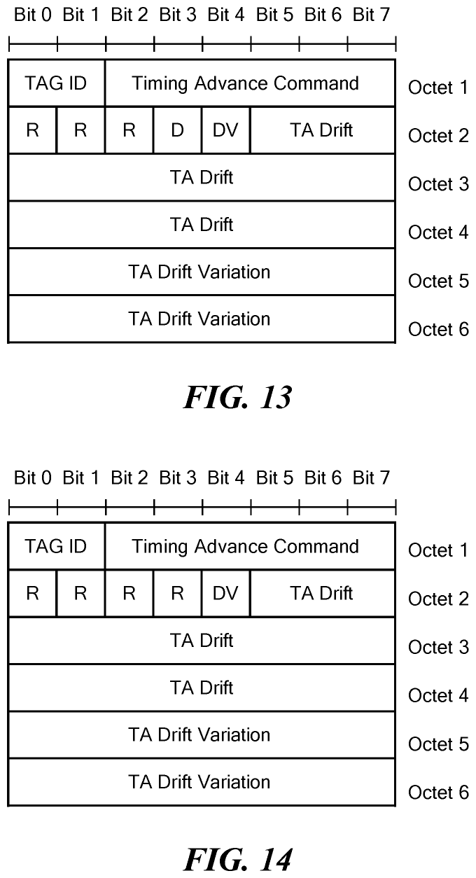

FIG. 13 illustrates another timing diagram with an Extended Absolute Timing Advance Command MAC CE format example with separately optional TA drift and optional TA drift variation, where the presence of each of which is controlled by a flag of its own, according to some embodiments of the present disclosure. The “D” bit may indicate the presence or absence of the TA Drift parameter. Set to 1 indicates presence, set to 0 indicates absence. The “DV” bit indicates the presence or absence of the TA Drift Variation parameter. Set to 1 indicates presence, set to 0 indicates absence. The bits indicated by “R” are reserved, should be set to 0 by the sender (e.g., UE 22 and/or network node 16) and should be ignored by the receiver (e.g., UE 22 and/or network node 16). With this format, the new MAC CE may include optional TA drift and TA drift variation parameters, where the presence of each of them may be separately controlled by a single-bit flag, in addition to the regular content of a Timing Advance Command MAC CE.

In some embodiments, an alternative to using an optionally included TA drift parameter and an optionally included TA drift variation is to use three MAC CE formats, one including a TA drift parameter and TA drift variation parameter, on including a TA drift parameter but no TA drift variation parameter, and one which neither includes a TA drift parameter nor a TA drift variation parameter. The network node 16 may be configured to choose which one to provide, e.g., on a case-by-case basis, group-wise basis, for a time period, etc. In some embodiments, which of the three MAC CE formats to use may be configurable, e.g., as indicated in and/or based on the system information.

FIG. 14 illustrates another example timing diagram with an Extended Absolute Timing Advance Command MAC CE format example with mandatory TA drift and optional TA drift variation, where the presence of the TA drift variation is controlled by a flag (i.e., a single bit indicator), according to some embodiments. The “DV” bit indicates the presence or absence of the TA Drift Variation parameter. Set to 1 indicates presence, set to 0 indicates absence. The bits indicated by “R” are reserved, may be set to 0 by the sender (e.g., UE 22 and/or network node 16) and may be ignored by the receiver (e.g., UE 22 and/or network node 16). With this format, the new MAC CE may a TA drift parameter and an optional TA drift variation parameter, where the presence of the optional TA drift variation parameter is controlled by a single-bit flag, in addition to the regular content of a Timing Advance Command MAC CE.

In some embodiments, an alternative to using an optionally included TA drift variation parameter is to use two MAC CE formats, one including a TA drift parameter and a TA drift variation parameter and one including a TA drift parameter but not TA drift variation parameter, and the network node 16 may be configured to choose which one to provide, e.g., on a case-by-case basis, group-wise basis, for a time period, etc. In some embodiments, which of the two MAC CE formats to use may be configurable, e.g., based on and/or as indicated by the system information.

In some embodiments, as an additional option, a corresponding new Extended Absolute Timing Advance Command MAC CE may be specified, wherein the TA information in the MAC CE may be interpreted as absolute, and when this value has been applied, it may subsequently be modified in accordance with the TA drift information (optionally including TA drift variation information) in the Extended Absolute Timing Advance Command MAC CE.

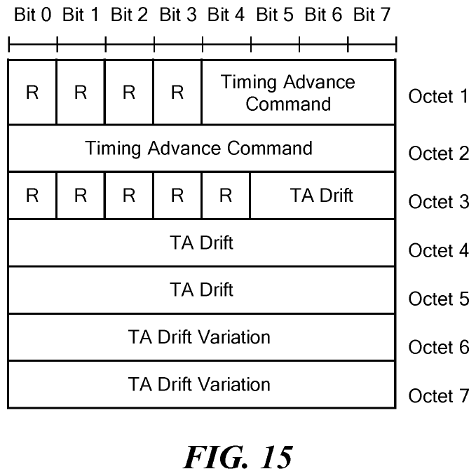

FIG. 15 illustrates another timing diagram with an Extended Absolute Timing Advance Command MAC CE format example with TA drift and TA drift variation, according to some embodiments of the present disclosure. The bits indicated by “R” are reserved, should be set to 0 by the sender (e.g., UE 22 and/or network node 16) and should be ignored by the receiver (e.g., UE 22 and/or network node 16).

In some embodiments, similar format examples as illustrated above for the new Extended Timing Advance Command MAC CE may also be applied to the Extended Absolute Timing Advance Command MAC CE, e.g., with TA drift information limited to the TA drift (i.e. without TA drift variation), and optional presences of a TA drift parameter and/or a TA drift variation parameter controlled by one or two single-bit flags, or with TA drift information including a mandatory TA drift parameter and an optional TA drift variation parameter whose presence is controlled by a single bit flag.

### Additional Options and Variants

Generalizing, the use of a new MAC CE of the type described above does not necessarily have to be tied to extension of a UE's 22 operation after expiration of its GNSS validity duration in IoT NTN. It may be used both in IoT NTN and NR NTN and in general in LTE and NR, also without any relation to a GNSS validity duration, in some embodiments.

According to version 17.3.0 of 3GPP TS 38.211, in NR NTN the UE 22 should use a timing advance in accordance with the following formula:

Uplink frame number i for transmission from the UE shall start

$${T}_{TA} = ( {N}_{TA} + {N}_{TA , offset} + {N}_{TA , adj}^{common} + {N}_{TA , adj}^{UE} ) {T}_{c}$$

before the start of the corresponding downlink frame (i.e. downlink frame number i) at the UE 22, where
T_{TA} is the timing advance,
N_{TA} reflects the accumulated adjustments signaled using a Timing Advance Command in a Random Access Response message (or a MsgB) and subsequent Timing Advance Command MAC Ces (and/or an Absolute Timing Advance Command MAC CE).
N_{TA,offset} is a fixed offset value configured by the network (and in absence of a configuration, the UE 22 determines a default value).

$${N}_{TA , adj}^{common}$$

is the Common TA which is a value representing the RTT on the feeder link or part of the feeder link between the satellite and the UL/DL alignment/time synchronization reference point. The UE 22 calculates it from the up to three related parameters broadcast in the system information, in NR NTN denoted as:
   ta-Common-r17, which represents the Common TA at the epoch time associated with this configuration (in IoT NTN the corresponding parameter is denoted as nta-Common-r17),
   ta-CommonDrift-r17, which is the time derivative of the Common TA and which facilitates for the UE 22 to calculate how the Common TA changes with time (in IoT NTN the corresponding parameter is denoted as nta-CommonDrift-r17),
   ta-CommonDriftVariant-r17, which is the second time derivative of the Common TA and which facilitates for the UE 22 to calculate how the Common TA changes with time (in IoT NTN the corresponding parameter is denoted as nta-CommonDriftVariation-r17).

$${N}_{TA , adj}^{UE}$$

path between the UE 22 and the satellite. The UE 22 calculates it based on the UE's 22 position and the satellite's position, where the satellite's position is derived from the satellite's ephemeris data which is broadcast in the system information.
T_{c} is the sampling time in NR, which is 0.509 ns.

The TA is calculated in a similar way for IoT NTN.

In some embodiments, the TA adjustments triggered by the new MAC CE (e.g. the Extended Timing Advance Command MAC CE) is associated with a new parameter to be included in the TA calculation formula, e.g. denoted as N_{TA2}. The TA adjustments triggered by the new MAC CE affect (i.e. are reflected in) this new parameter. The above formula for the timing advance (T_{TA}) then becomes:

$${T}_{TA} = ( {N}_{TA} + {N}_{TA 2} + {N}_{TA , offset} + {N}_{TA , adj}^{common} + {N}_{TA , adj}^{UE} ) {T}_{c}$$

Furthermore, in some embodiments, the UE 22 is configured to set the new parameter to zero, i.e. N_{TA2}=0, upon calculation of a new

$${N}_{TA , adj}^{UE}$$

based on a new GNSS position measurement. This UE 22 behavior may be specified in the standard, but an alternative is to make it configurable (e.g., by network node 16). To this end, the network node 16 may configure whether the UE 22, upon calculation of a new

$${N}_{TA , adj}^{UE}$$

based on a new GNSS position measurement, should set N_{TA2}=0 or leave N_{TA2} unchanged. The network may use RRC signaling for this configuration or signal it in a MAC CE.

As another option, the network node 16 may be configured to indicate in a MAC CE, e.g., in the Extended Timing Advance Command MAC CE (or in the Extended Absolute Timing Advance Command MAC CE) or in another new MAC CE, that the present value of N_{TA} should be added to N_{TA2} and then N_{TA} should be set to zero. In the Extended Timing Advance Command MAC CE or Extended Absolute Timing Advance Command MAC CE this may be indicated, e.g., using one of the reserved bits (indicated by “R”) in the MAC CE format examples illustrated above This behavior may also be signaled using RRC signaling or it may be specified in a standard specification or signaled via the system information, e.g. applying to UEs 22 supporting a certain release of the 3GPP standard, and/or UEs 22 of a certain type or category or UEs 22 with a certain capability or certain capabilities (where the capability may e.g., be that the UE 22 supports this behavior).

In some embodiments, as yet another option, the network node 16 may be configured to indicate in a MAC CE, e.g., in another new MAC CE, or using RRC signaling, or via the system information, that a UE 22 should set N_{TA} to zero, i.e. N_{TA}=0, upon calculation of a new

$${N}_{TA , adj}^{UE}$$

based on a new GNSS position measurement. Alternatively, this may be specified in a standard specification or signaled via the system information, e.g., applying to UEs 22 supporting a certain release of the 3GPP standard, and/or UEs 22 of a certain type or category or UEs 22 with a certain capability or certain capabilities (where the capability may, e.g., be that the UE 22 supports this behavior).

Some embodiments may include one or more of the following:

Embodiment A1. A network node configured to communicate with a wireless device (WD), the network node configured to, and/or comprising a radio interface and/or comprising processing circuitry configured to:
determine a Global Navigation Satellite System (GNSS) validity configuration enabling the WD to conditionally transmit on an uplink channel to the network node if a GNSS validity duration timer has expired;
transmit GNSS validity configuration information to the WD;
detect an expiration of the GNSS validity duration timer; and
receive signaling on the uplink channel to the network node after the expiration of the validity duration timer based on the GNSS validity configuration information.

Embodiment A2. The network node of Embodiment A1, wherein the network node is further configured to:
start an extension timer in response to the expiration of the validity duration timer; and
transmit, to the WD, an indication configured to cause the WD to stop reacquiring a GNSS position and/or stop the extension timer based on the WD having no additional pending uplink data to send to the network node.

Embodiment A3. The network node of Embodiment A1, wherein the network node is further configured to:
determine a transmission timing error of the WD;
determine a drift parameter for the WD;
transmit a timing advance command to the WD based on the transmission timing error being below a threshold error level; and
the receiving of the signaling on the uplink channel from the WD after the expiration uses a GNSS measurement performed prior to the expiration of the validity duration timer and is based on the drift parameter.

Embodiment B1. A method implemented in a network node, the method comprising:
determining a Global Navigation Satellite System (GNSS) validity configuration enabling the WD to conditionally transmit on an uplink channel to the network node if a GNSS validity duration timer has expired;
transmitting GNSS validity configuration information to the WD;
detecting an expiration of the GNSS validity duration timer; and
receiving signaling on the uplink channel to the network node after the expiration of the validity duration timer based on the GNSS validity configuration information.

Embodiment B2. The method of Embodiment B1, wherein the method further comprises:
starting an extension timer in response to the expiration of the validity duration timer; and
transmitting, to the WD, an indication configured to cause the WD to stop reacquiring a GNSS position and/or stop the extension timer based on the WD having no additional pending uplink data to send to the network node.

Embodiment B3. The method of Embodiment B1, wherein the method further comprises:
determining a transmission timing error of the WD;
determining a drift parameter for the WD;
transmitting a timing advance command to the WD based on the transmission timing error being below a threshold error level; and
the receiving of the signaling on the uplink channel from the WD after the expiration uses a GNSS measurement performed prior to the expiration of the validity duration timer and is based on the drift parameter.

Embodiment C1. A wireless device (WD) configured to communicate with a network node, the WD configured to, and/or comprising a radio interface and/or processing circuitry configured to:
receive, from the network node, Global Navigation Satellite System (GNSS) validity configuration information enabling the WD to conditionally transmit on an uplink channel to the network node if a GNSS validity duration timer has expired;
detect an expiration of the GNSS validity duration timer; and
transmit signaling on the uplink channel to the network node after the expiration of the validity duration timer based on the GNSS validity configuration information.

Embodiment C2. The WD of Embodiment C1, wherein the WD is further configured to:
start an extension timer in response to the expiration of the validity duration timer; and
receive, from the network node, an indication configured to cause the WD to stop reacquiring a GNSS position and/or stop the extension timer based on the WD having no additional pending uplink data to send to the network node.

Embodiment C3. The WD of Embodiment C1, wherein the WD is further configured to:
receive a timing advance command from the network node based on a transmission timing error of the WD being below a threshold error level;
perform a GNSS measurement prior to the expiration of the validity duration timer; and
the transmitting of the signaling on the uplink channel to the network node after the expiration using the GNSS measurement and further being based on a drift parameter indicated in the timing advance command.

Embodiment D1. A method implemented in a wireless device (WD), the method comprising:
receiving, from the network node, Global Navigation Satellite System (GNSS) validity configuration information enabling the WD to conditionally transmit on an uplink channel to the network node if a GNSS validity duration timer has expired;
detecting an expiration of the GNSS validity duration timer; and
transmitting signaling on the uplink channel to the network node after the expiration of the validity duration timer based on the GNSS validity configuration information.

Embodiment D2. The method of Embodiment D1, further comprising:
starting an extension timer in response to the expiration of the validity duration timer; and
receiving, from the network node, an indication configured to cause the WD to stop reacquiring a GNSS position and/or stop the extension timer based on the WD having no additional pending uplink data to send to the network node

Embodiment D3. The method of Embodiment D1, wherein the method further comprises:
receiving a timing advance command from the network node based on a transmission timing error of the WD being below a threshold error level;
performing a GNSS measurement prior to the expiration of the validity duration timer; and
the transmitting of the signaling on the uplink channel to the network node after the expiration using the GNSS measurement and further being based on a drift parameter indicated in the timing advance command.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The following provides non-limiting examples of how certain aspects of the proposed solutions could be implemented within the framework of a specific communication standard. In particular, the following are examples of how the proposed solutions could be implemented within the framework of a 3GPP TSG RAN standard. The changes described are merely intended to illustrate how certain aspects of the proposed solutions could be implemented in a particular standard. However, the proposed solutions could also be implemented in other suitable manners, both in the 3GPP Specification and in other specifications or standards.

### Enhancements to Enable UL Transmission Despite GNSS Validity Duration Expiry

Minor enhancements to closed-loop mechanism may be needed to enable an energy efficient operation that avoids GNSS position fix. For instance, the network should have the possibility to indicate to the UE if it can continue to transmit on the uplink even if the GNSS position validity duration has expired. This is essential because the role of closed-loop timing control is to reduce the need of GNSS reacquisition-so even if the GNSS position is invalid, the network may continue to send TACs to help the UE maintain its uplink synchronization. The following proposals are disclosed.

Proposal 1 eNB to indicate a time duration X to an IoT NTN UE in connected mode such that the UE can continue its uplink transmission for a time duration X after GNSS validity duration has expired.

Note that it is up to RAN2 to develop specifications to support the above proposal while minimizing the specification impact. For example, it can be achieved by extending the GNSS validity duration, and/or introducing a new validity duration parameter during which the UE is allowed to transmit.

### UE-Specific Timing Drift

Moreover, if the network solely relies on TACs to correct UE's timing before or after GNSS position validity expiry, the signalling overhead could be very high due to the large timing drift. A potential solution is to allow the UE to compute its TA values (until a new TAC is received) based on the service link and common TA drift parameters, where the parameters related to the service link drift can either be tracked by the UE or indicated by the network. This semi-autonomous approach may help reduce the signalling overhead as fewer TACs will be needed; and the UE need not perform a GNSS position fix to correct its timing.

For IoT NTN, it is possible for a network to broadcast drift parameters for common TA. If the network additionally indicates the UE-specific timing drift parameters for the TA to a UE in connected mode, it may enable the UE to update its TA values accordingly (until a new TAC is received) to compensate for its inaccurate GNSS position.

Proposal 2 Network to optionally indicate UE-specific timing drift parameters to an IoT NTN UE in connected mode.

Proposal 3 Upon GNSS position expiry in connected mode, an IoT NTN UE to use UE-specific drift information (in addition to common TA parameters) to calculate TA values before receiving the next TA command.

Unlike the closed loop TA mechanism, the closed loop frequency adjustment (FA) mechanism is not currently supported. Based on the results reported by the proponents of closed-loop FA, it seems that the frequency error in IoT NTN is comparable to that in terrestrial networks, barring some corner cases. Therefore, design and introduction of a new closed-loop FA signalling mechanism for IoT NTN may not be needed.

Proposal 4 Closed loop frequency correction mechanism shall not be specified unless absolutely necessary.

Proposal 5 If eNB aperiodically triggers UE to make GNSS measurement, RRC signalling is used.

### GNSS Measurement Trigger Time

RAN1 has listed two alternatives for GNSS gap trigger time. Alt 1 should be agreed where X can be a configured value. As for Alt 2, once the timer-based mechanism is in place, this will already be supported if no GNSS measurement gap trigger is received by the UE.

### Length of GNSS Measurement Gap

Before accessing the network, the UE will already have a valid GNSS position. If the GNSS position fix is made at least every 4 hours, it will typically correspond to a hot start. As a result, focus may be on hot start when specifying the possible values for the GNSS gap duration. Nonetheless, due to UE mobility, there might be scenarios where a warm start will be needed. Therefore, the following proposal is disclosed.

Proposal 6 Network to configure the GNSS measurement gap duration from the following set of values: {1, 2, 5, X} seconds, where X is FFS.

### GNSS Measurements During C-DRX

RAN1 has already agreed to support network-triggered GNSS measurements, which can be realized using GNSS measurement gaps. Additionally, it may be possible for a UE to acquire a position fix during the inactive mode of connected mode discontinuous reception (C-DRX). It may be more appropriate to hold the discussion related to C-DRX in RAN2.

Proposal 7 The discussion on supporting UE-triggered GNSS measurements during the sleep mode of C-DRX should be left to RAN2.

When a UE reacquires GNSS position fix in connected mode, it should report GNSS assistance information where RAN2 can decide whether to use MAC or RRC for signalling. At least the GNSS validity duration should always be reported after GNSS reacquisition.

Proposal 8 A UE in connected mode shall always report its GNSS validity duration after GNSS reacquisition.

It is essential for the network to know the UE's latest GNSS validity duration so that it can configure a GNSS measurement gap accordingly. The UE may report its GNSS validity duration after every GNSS position fix regardless of if it changes or not. It is also a simple way to indicate the success of GNSS measurement to the eNB.

Proposal 9 If the eNB receives the GNSS validity duration from the UE, it concludes that the UE's latest GNSS measurement was successful.

Finally, the format of reporting the GNSS measurement time duration may be considered. Before accessing the network, the UE will already have a valid GNSS position. If the GNSS position fix is made at least every 4 hours, it corresponds to a hot start. As a result, hot start when specifying the format of GNSS measurement time duration for IoT NTN may be needed. Nonetheless, due to UE mobility, there might be scenarios where a warm start will be needed. Therefore, consider the following proposal.

Proposal 10 UE to report its GNSS measurement time duration in connected mode using a 2-bit field from the following set of values: {1, 2, 5, X} seconds, where X is FFS.

Only a single value for GNSS position fix time duration may be reported. Otherwise, if multiple values are reported by the UE, the eNB cannot know which value to use while configuring a GNSS measurement gap for the UE.

Proposal 11 UE reports only one value (from the set of possible values) for the GNSS measurement time duration in RRC connected state.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1.-10. (canceled)

11. A method in a user equipment, UE, configured to communicate with a network node, the method comprising:
receiving, from the network node, Global Navigation Satellite System (GNSS) validity configuration information to enable the UE to transmit on an uplink channel to the network node when a GNSS validity duration has expired;
transmitting signaling on the uplink channel to the network node after the expiration of the GNSS validity duration based on the GNSS validity configuration information; and
transmitting the GNSS validity duration to the network node.

12. The method of claim 11, further comprising starting an extension timer in response to the expiration of the GNSS validity duration.

13. The method of claim 12, further comprising reacquiring GNSS position upon expiry of the extension timer.

14. The method of claim 12, further comprising reacquiring GNSS position before expiry of the extension timer in response to a trigger.

15. (canceled)

16. The method of claim 11, further comprising receiving a gap duration for attempting to reacquire GNSS position.

17. (canceled)

18. The method of claim 11, further comprising receiving a GNSS position reacquisition command during a reception time interval established by a start of a reception timer.

19. The method of claim 18, further comprising stopping the reception timer upon reception of a GNSS measurement gap command from the network node.

20.-30. (canceled)

31. A method in a network node configured to communicate with a user equipment, UE, the method comprising:
determining a Global Navigation Satellite System (GNSS) validity configuration enabling the UE to conditionally transmit on an uplink channel to the network node when a GNSS validity duration has expired;
transmitting the GNSS validity configuration information to the UE;
receiving signaling on the uplink channel to the network node after the expiration of the GNSS validity duration based on the GNSS validity configuration information; and
receiving the GNSS validity duration from the UE.

32. (canceled)

33. The method of claim 31, wherein the GNSS validity configuration information includes a duration of an extension timer.

34. The method of claim 33, further comprising transmitting a timing advance command, TAC, during one of the GNSS validity duration and the duration of the extension timer.

35. The method of claim 34, further comprising transmitting timing advance, TA, drift information.

36. (canceled)

37. (canceled)

38. The method of claim 35, wherein the TAC and the TA drift information is included in a medium access control, MAC, control element, CE.

39. The method of claim 33, wherein the duration of the extension timer is based at least in part on a GNSS validity duration reported by the UE.

40. The method of claim 31, wherein the GNSS validity configuration information includes a GNSS gap duration for attempting reacquisition of GNSS position by the UE.

41. A user equipment, UE, configured to communicate with a network node, the UE configured to:
receive, from the network node, Global Navigation Satellite System (GNSS) validity configuration information enabling the UE to conditionally transmit on an uplink channel to the network node when a GNSS validity duration has expired;
transmit signaling on the uplink channel to the network node after the expiration of the GNSS validity duration based on the GNSS validity configuration information; and
transmit the GNSS validity duration to the network node.

42. The UE according to claim 41, wherein the UE is further configured to start an extension timer in response to the expiration of the GNSS validity duration.

43. The UE according to claim 42, wherein the UE is further configured to reacquire GNSS position upon expiry of the extension timer.

44. The UE according to claim 41, wherein the UE is further configured to reacquire GNSS position before expiry of the extension timer in response to a trigger.

45. A network node configured to communicate with a user equipment, UE, the network node configured to:
determine a Global Navigation Satellite System (GNSS) validity configuration enabling the UE to conditionally transmit on an uplink channel to the network node when a GNSS validity duration has expired;
transmit the GNSS validity configuration information to the UE;
receive signaling on the uplink channel to the network node after the expiration of the GNSS validity duration based on the GNSS validity configuration information; and
receive the GNSS validity duration from the UE.

46. The network node according to claim 45, wherein the GNSS validity configuration information includes a duration of an extension timer.
